(19) United States
(12) Patent Application Publication
(10) Pub. No.: US 2026/0212512 A1
(43) Pub. Date: Jul. 23, 2026

(54) IMAGE ANALYSIS DEVICE, IMAGE ANALYSIS SYSTEM, AND IMAGE ANALYSIS METHOD

(71) Applicant: Mitsubishi Electric Corporation, Tokyo (JP)

(72) Inventors: Toshiaki KUBO, Tokyo (JP); Kazuki DEGUCHI, Tokyo (JP)

(73) Assignee: Mitsubishi Electric Corporation, Tokyo (JP)

(21) Appl. No.: 19/140,377

(22) PCT Filed: Feb. 27, 2023
(86) PCT No.: PCT/JP2023/007040

§ 371 Date: Jun. 18, 2025

(51) Int. Cl. G06T 7/20; G06T 7/70

(52) U.S. Cl. CPC G06T 7/20; G06T 7/70

(57) ABSTRACT

An image analysis device includes a time-series image data correction unit to receive time-series image data captured by a moving image capturing device and time-series position posture information acquired by a position posture information acquisition unit to acquire position posture information indicating a position and posture of the image capturing device, to correct the time-series image data based on the time-series position posture information, and thereby to generate time-series corrected image data, and an image analysis unit to generate an image analysis result indicating condition of an object by analyzing the condition of the object included in the time-series image data based on the time-series corrected image data.

### TECHNICAL FIELD

The present disclosure relates to an image analysis device, an image analysis system, an image analysis method and an image analysis program.

### BACKGROUND ART

Conventionally, there has been proposed a device that calculates the distance to an object (e.g., pedestrian or another vehicle) based on a captured image of the object photographed by a camera as an image capturing device mounted on mobile equipment (e.g., automobile or robot) (see Patent Reference 1, for example).

### PRIOR ART REFERENCE

### Patent Reference

Patent Reference 1: WO 2019/181284

### SUMMARY OF THE INVENTION

### Problem to Be Solved by the Invention

However, in the device in the Patent Reference 1, there is a problem in that accuracy of analysis of condition of the object deteriorates when analyzing the condition of the object based on time-series image data captured by a moving image capturing device.

An object of the present disclosure, which has been made to resolve the above-described problem with the conventional technology, is to analyze the condition of the object with high accuracy based on time-series image data captured by a moving image capturing device and position posture information on the image capturing device.

### Means for Solving the Problem

An image analysis device in the present disclosure is a device including a time-series image data correction unit to receive time-series image data captured by a moving image capturing device and time-series position posture information acquired by a position posture information acquisition unit to acquire position posture information indicating a position and posture of the image capturing device, to correct the time-series image data based on the time-series position posture information, and thereby to generate time-series corrected image data; and an image analysis unit to generate an image analysis result indicating condition of an object by analyzing the condition of the object included in the time-series image data based on the time-series corrected image data.

Another image analysis device in the present disclosure is a device including an image analysis unit to receive time-series image data captured by a moving image capturing device and to output an image analysis result indicating condition of an object by analyzing the condition of the object included in the time-series image data; and an analysis result correction unit to receive the image analysis result and time-series position posture information acquired by a position posture information acquisition unit to acquire position posture information indicating a position and posture of the image capturing device and to generate a corrected image analysis result by correcting the image analysis result based on the time-series position posture information.

### Effect of the Invention

According to the present disclosure, the condition of the object can be analyzed with high accuracy based on time-series image data captured by a moving image capturing device and the position posture information on the image capturing device.

### BRIEF DESCRIPTION OF THE DRAWINGS

FIG. 1 is a block diagram showing the configuration of an image analysis system (including an image analysis device) according to a first embodiment.

FIG. 2 is a diagram showing an example of the hardware configuration of the image analysis device according to the first embodiment.

FIG. 3 is a diagram showing another example of the hardware configuration of the image analysis device according to the first embodiment.

FIG. 4 is a flowchart showing the operation of the image analysis device according to the first embodiment.

FIGS. 5A and 5B are diagrams regarding a comparative example #1 and showing a situation where an area a person is passing through is photographed by a fixed camera and time-series image data acquired by photographing the area the person passes through.

FIGS. 6A and 6B are diagrams regarding a comparative example #2 and showing a situation where an area a person is passing through is photographed by a moving image capturing device and the time-series image data acquired by photographing the area the person passes through.

FIGS. 7A and 7B are diagrams regarding an operation example #1 of the image analysis device according to the first embodiment and showing a situation where an area a person is passing through is photographed by the moving image capturing device and time-series corrected image data acquired by photographing the area the person passes through.

FIGS. 8A and 8B are diagrams regarding an operation example #2 of the image analysis device according to the first embodiment and showing a situation where an area a person is passing through is photographed by the moving image capturing device and the time-series corrected image data acquired by photographing the area the person passes through.

FIGS. 9A and 9B are diagrams regarding a comparative example #3 and showing a situation where an area a plurality of moving people are passing through is photographed by the moving image capturing device and the time-series image data acquired by photographing the area the plurality of people pass through.

FIGS. 10A and 10B are diagrams regarding an operation example #3 of the image analysis device according to the first embodiment and showing a situation where an area a plurality of moving people are passing through is photographed by the moving image capturing device and the time-series corrected image data acquired by photographing the area the plurality of people pass through.

FIGS. 11A and 11B are diagrams regarding a comparative example #4 and showing a situation where an area a plurality of stagnated people 42 are passing through is photographed by the moving image capturing device and the time-series image data acquired by photographing the area the plurality of people pass through.

FIGS. 12A and 12B are diagrams regarding an operation example #4 of the image analysis device according to the first embodiment and showing a situation where an area a plurality of stagnated people are passing through is photographed by the moving image capturing device and the time-series corrected image data acquired by photographing the area the plurality of people pass through.

FIG. 13 is a block diagram showing the configuration of an image analysis system (including an image analysis device) according to a second embodiment.

FIG. 14 is a flowchart showing the operation of the image analysis device according to the second embodiment.

FIGS. 15A, 15B and 15C are diagrams regarding an operation example #5 of the image analysis device according to the second embodiment and showing a situation where an area a moving person is passing through is photographed by the moving image capturing device, the time-series image data acquired by photographing the area the person passes through, and correction of the image analysis result.

### MODE FOR CARRYING OUT THE INVENTION

An image analysis device, an image analysis system, an image analysis method and an image analysis program according to each embodiment will be described below with reference to the drawings. The following embodiments are just examples and it is possible to appropriately combine embodiments and appropriately modify each embodiment.

### (1) First Embodiment

### (1-1) Configuration

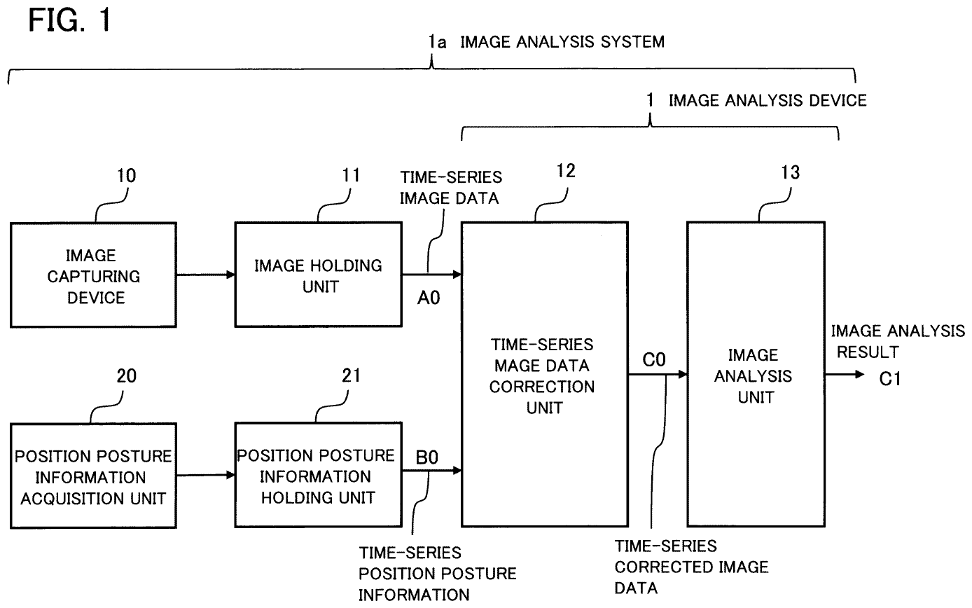

FIG. 1 is a block diagram showing the configuration of an image analysis system la (including an image analysis device 1) according to a first embodiment. The image analysis device 1 is a device capable of executing an image analysis method according to the first embodiment. The image analysis system la includes an image capturing device 10 such as a camera, an image holding unit 11 as a storage device that temporarily holds image data captured by the image capturing device 10, a position posture information acquisition unit 20 that acquires position posture information indicating a position and posture of the image capturing device 10, a position posture information holding unit 21 as a storage device that temporarily holds the position posture information, a time-series image data correction unit 12, and an image analysis unit 13.

The image capturing device 10 is provided on a mobile object. The mobile object is, for example, mobile equipment such as a mobile robot as a robot having a moving function, an automobile, or an unmanned aircraft (generally referred to as a “drone”). The mobile robot is, for example, a patrol guard robot as an autonomous traveling vehicle that patrols in a previously set area. The image capturing device 10 is desired to be a device having a function of changing a photographing direction (i.e., a function of making a pan-tilt movement). The image capturing device 10 can be a device that moves by being carried by a person (e.g., wearable camera), and the mobile object in this case is the person carrying the image capturing device 10.

The image holding unit 11 temporarily stores the image data outputted from the image capturing device 10 and outputs time-series image data A0. The time-series image data A0 is, for example, image data at predetermined time intervals (e.g., times t, t+1, t+2, . . . which will be described later). The image holding unit 11 can also be a part of the image capturing device 10. Alternatively, the image holding unit 11 can also be a part of the image analysis device 1.

The position posture information acquisition unit 20 is a device capable of detecting the position and the posture of the image capturing device 10. The posture of the image capturing device 10 is information (e.g., camera parameter) indicating the photographing direction of the image capturing device 10. The position posture information acquisition unit 20 is, for example, a GNSS (Global Navigation Satellite System) device such as a GPS (Global Positioning System) provided on the mobile object, a device having an own position estimation function such as SLAM (Simultaneous Localization and Mapping), a positioning device using a beacon, or the like. Further, the image capturing device 10 includes a device that acquires information indicating pan-tilt-roll amounts at a time of changing the photographing direction. While the position posture information acquisition unit 20 is generally provided on the mobile object equipped with the image capturing device 10, the position posture information acquisition unit 20 does not necessarily have to be provided on the mobile object.

The position posture information holding unit 21 temporarily stores the position posture information outputted from the position posture information acquisition unit 20 and outputs time-series position posture information B0. The time-series position posture information B0 is, for example, position posture information at predetermined time intervals (e.g., times t, t+1, t+2, . . . which will be described later). The time-series position posture information B0 is information corresponding to the time-series image data A0. The position posture information holding unit 21 can also be a part of the position posture information acquisition unit 20. Alternatively, the position posture information holding unit 21 can also be a part of the image analysis device 1.

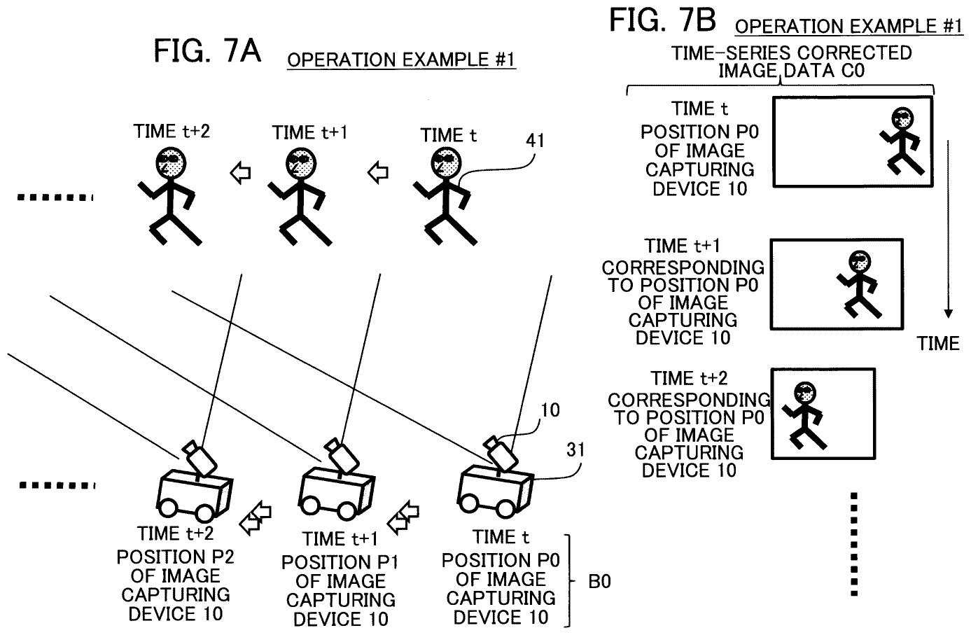

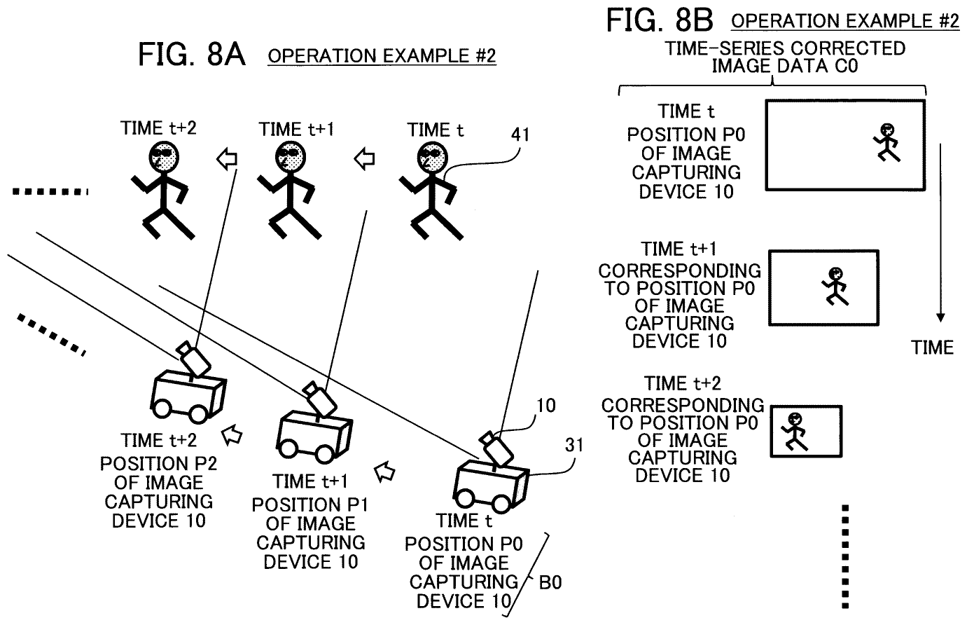

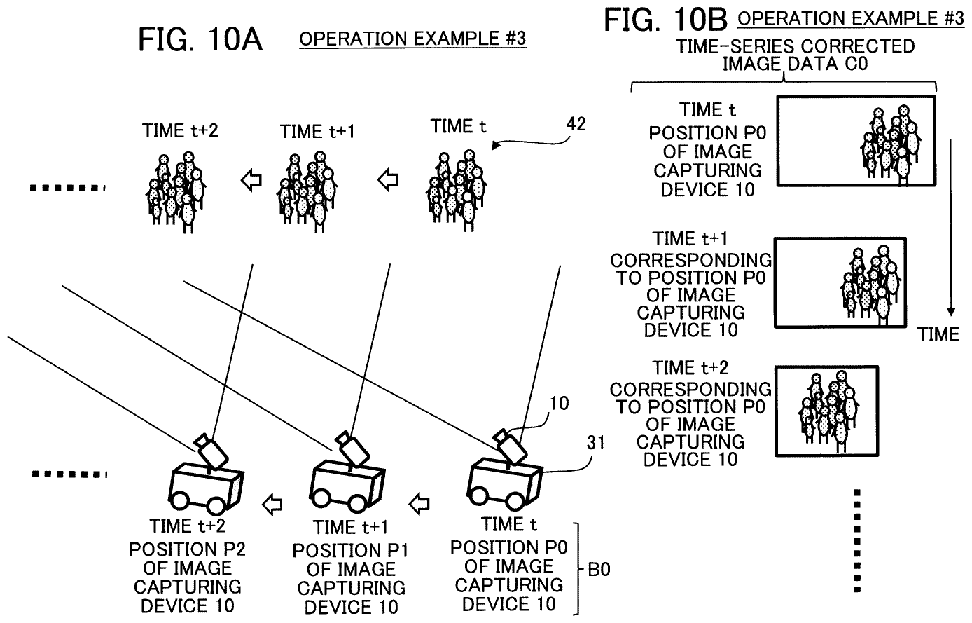

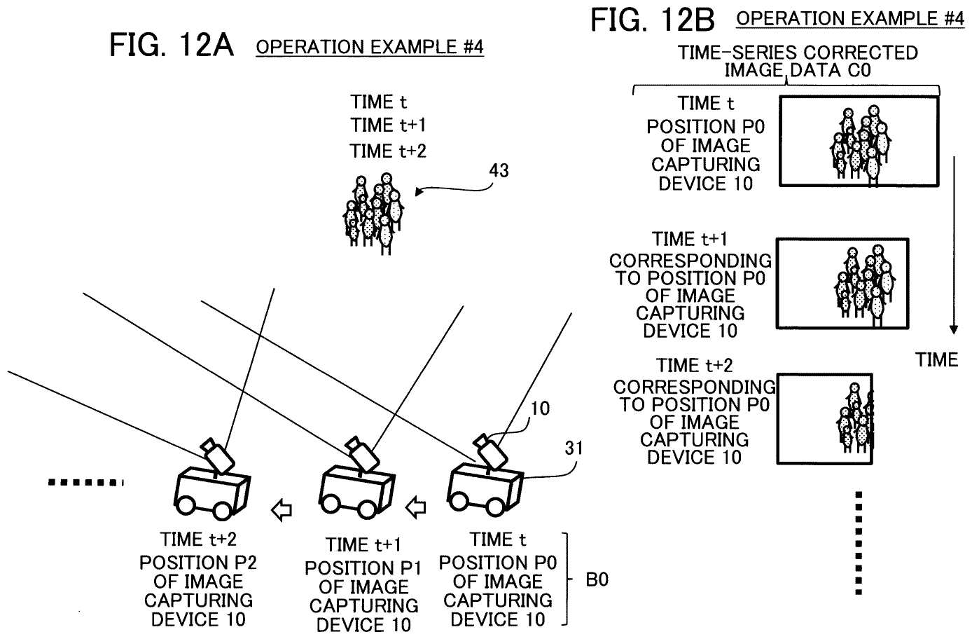

The time-series image data correction unit 12 receives the time-series image data A0 captured by the moving image capturing device 10 and the time-series position posture information B0 acquired by the position posture information acquisition unit 20 that acquires the position posture information indicating the position and the posture of the image capturing device 10, corrects the time-series image data A0 based on the time-series position posture information B0, and thereby generates time-series corrected image data C0. The time-series image data correction unit 12 determines a reference time, in the time in which the time-series image data A0 were captured, based on the time-series position posture information B0 and generates the time-series corrected image data C0 by modifying each piece of the time-series image data A0 into image data that could have been acquired if the image capturing device 10 had been situated at the position at the reference time. Examples of the time-series corrected image data C0 are shown in FIG. 7B, FIG. 8B, FIG. 10B and FIG. 12B which will be explained later.

The image analysis unit 13 outputs an image analysis result C1 indicating condition of an object by analyzing the condition of the object included in the time-series image data A0 based on the time-series corrected image data C0. The object is, for example, a person, a crowd made up of a plurality of people, another piece of mobile equipment (e.g., another vehicle or another mobile robot), or the like. The condition of the object is, for example, an action of a person, whether a person is moving or stopped, whether a crowd is stagnated or moving, or the like. Specifically, the condition of the object indicated by the image analysis result C1 is, for example, the action of a person, movement of a crowd, movement of another piece of mobile equipment, or the like. The action of a person is, for example, a person is running, a person is standing still, a person is crouching, a person has fallen down, a plurality of people have gathered, a person is dancing, a person is on the rampage, people are fighting with each other, or the like. Further, the condition of the object indicated by the image analysis result C1 can be there is a crowd, a crowd is stagnated without moving, a crowd is moving, or the like. Furthermore, the condition of the object indicated by the image analysis result C1 can be another piece of mobile equipment is moving, another piece of mobile equipment is stopped at the center of a passage without moving, another piece of mobile equipment has collided with a thing, or the like.

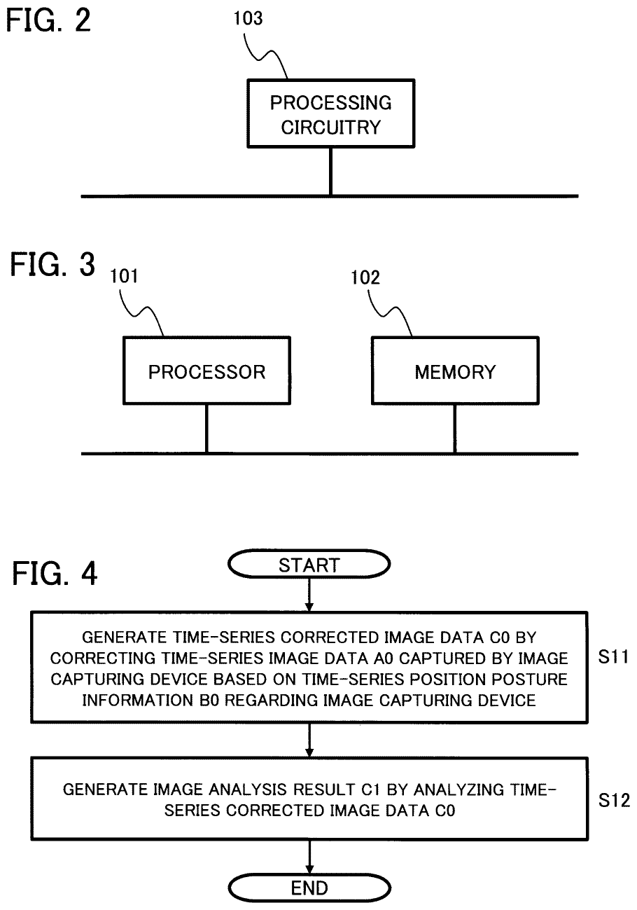

FIG. 2 is a diagram showing an example of the hardware configuration of the image analysis device 1. As shown in FIG. 2, parts forming the image analysis device 1 are implemented by processing circuitry 103, for example. The processing circuitry 103 can be either dedicated hardware or circuitry including a CPU (Central Processing Unit) as a processor that executes a program stored in a memory. In the case where the processing circuitry 103 is dedicated hardware, the processing circuitry 103 can be, for example, a single circuit, a combined circuit, a programmed processor, a parallelly programmed processor, an ASIC (Application Specific Integrated Circuit), an FPGA (Field Programmable Gate Array) or a combination of some of these circuits.

FIG. 3 is a diagram showing another example of the hardware configuration of the image analysis device 1. As shown in FIG. 3, the processing circuitry forming the image analysis device 1 may be implemented by a memory 102 as a storage device (that can include a storage medium) storing a program (e.g., image analysis program according to the first embodiment) as software and a processor 101 such as a CPU that reads out and executes the image processing program. In this case, the image analysis device 1 is a computer, for example. The memory 102 is, for example, a semiconductor memory such as a RAM (Random Access Memory), a magnetic disk, or the like. Incidentally, the image analysis device 1 can also be a mixture of a configuration including the processing circuitry 103 in FIG. 2 and a configuration including the processor 101 and the memory 102 in FIG. 3.

### (1-2) Operation

FIG. 4 is a flowchart showing the operation of the image analysis device 1 according to the first embodiment. As shown in step S11 in FIG. 4, the time-series image data correction unit 12 receives the time-series image data A0 captured by the moving image capturing device 10 and the time-series position posture information B0 acquired by the position posture information acquisition unit 20, corrects the time-series image data A0 based on the time-series position posture information B0, and thereby generates the time-series corrected image data C0. Subsequently, as shown in step S12, the image analysis unit 13 generates and outputs the image analysis result C1 indicating the condition of the object by analyzing the condition of the object included in the time-series image data A0 based on the time-series corrected image data C0.

### (1-3) Comparative Examples #1 and #2, Operation Example #1

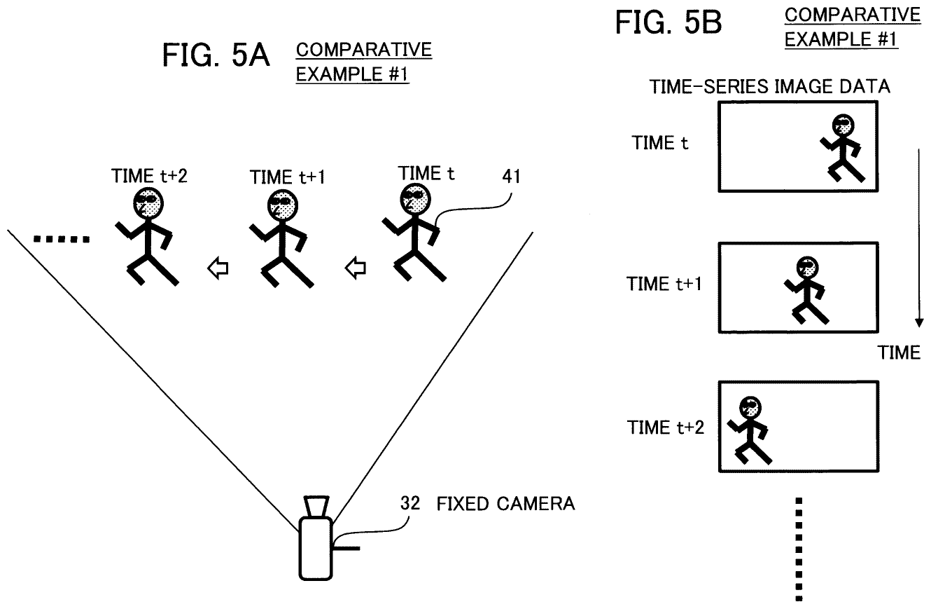

FIGS. 5A and 5B are diagrams regarding a comparative example #1 and showing a situation where an area a person 41 is passing through is photographed by a fixed camera 32 and the time-series image data acquired by photographing the area the person 41 passes through. When the moving person 41 is photographed by the fixed camera 32 as shown in FIG. 5A, the image analysis device in the comparative example #1 receiving the time-series image data from the fixed camera 32 recognizes that the position of the photographed person 41 is moving by comparing the time-series image data at the times t, t+1, t+2, . . . acquired by photographing the same photographing range with each other as shown in FIG. 5B. Put another way, in the case of using the fixed camera 32, each piece of the time-series image data has captured the same area as shown in FIG. 5B, and thus the image analysis device in the comparative example #1 is capable of outputting the image analysis result indicating that “the person 41 is moving” (“the person 41 is running” when the movement is fast) by means of image analysis. To sum up, the image analysis device in the comparative example #1 is capable of outputting the image analysis result with high accuracy in regard to the movement of the person 41 even though there is a drawback in that the distance between the fixed camera 32 and the person 41 as the object is long.

However, there are cases where the image capturing device 10 is mounted on a mobile robot 31 as a mobile object in order to widen a photographing area of the image capturing device 10.

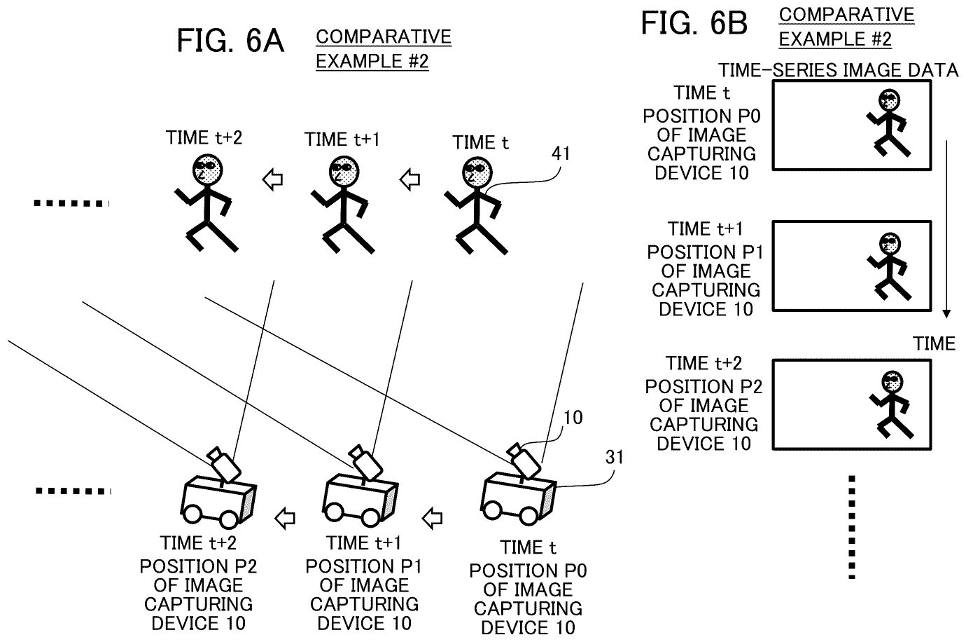

FIGS. 6A and 6B are diagrams regarding a comparative example #2 and showing a situation where an area a person 41 is passing through is photographed by a moving image capturing device 10 and the time-series image data acquired by photographing the area the person 41 passes through. As shown in FIG. 6A, when the object area (including the moving person 41, for example) is photographed by the moving image capturing device 10, not only the person 41 but also the position of the image capturing device 10 moves in order of positions P0, P1, P2, . . . and the photographing area also moves. Therefore, the image analysis device in the comparative example #2, executing the image analysis by using the time-series image data at the times t, t+1, t+2, . . . captured by the image capturing device 10, might generate an image analysis result like “the position of the photographed person is not moving” as shown in FIG. 6B. Put another way, in the case of using the moving image capturing device 10, each piece of the time-series image data has captured a different area as shown in FIG. 6B, and thus the image analysis device in the comparative example #2 might output the image analysis result indicating that “the person 41 is not moving” by means of the image analysis even though the person 41 is moving. To sum up, in the image analysis device in the comparative example #2, the accuracy of the image analysis in regard to the condition of the person 41 as the object is low.

FIGS. 7A and 7B are diagrams regarding an operation example #1 of the image analysis device 1 according to the first embodiment and showing a situation where an area a person 41 is passing through is photographed by the moving image capturing device 10 and the time-series corrected image data acquired by photographing the area the person 41 passes through. As shown in FIG. 7A, when the person 41 moving in approximately the same direction as the moving direction of the image capturing device 10 is photographed by the moving image capturing device 10, not only the person 41 but also the position of the image capturing device 10 moves in the order of the positions P0, P1, P2, . . . and the photographing area also moves. The time-series image data correction unit 12 of the image analysis device 1 according to the first embodiment receives the time-series image data A0 captured by the moving image capturing device 10 and the time-series position posture information B0 acquired by the position posture information acquisition unit 20, corrects the time-series image data A0 based on the time-series position posture information B0, and thereby generates the time-series corrected image data C0. As shown in FIG. 7B, the time-series image data correction unit 12 corrects the image data captured at the image capturing device 10's position P1 (time t+1) by using the image data captured at the image capturing device 10's position P0 (time t) as the reference as reference image data, and thereby generates image data that could have been acquired if the photographing had been performed at the image capturing device 10's position P0 as the reference (i.e., image data corresponding to the position P0). Similarly, as shown in FIG. 7B, the time-series image data correction unit 12 corrects the image data captured at the image capturing device 10's position P2 (time t+2) by using the image data captured at the image capturing device 10's position P0 (time t) as the reference as the reference image data, and thereby generates image data that could have been acquired if the photographing had been performed at the image capturing device 10's position P0 as the reference (i.e., image data corresponding to the position P0). Subsequently, the image analysis unit 13 outputs the image analysis result C1 indicating the condition of the object by analyzing the condition of the object included in the time-series image data A0 based on the time-series corrected image data C0. As shown in FIG. 7B, each piece of the time-series corrected image data C0 is the same as each other in the position and the posture of the image capturing device 10, and the image analysis device is capable of outputting the image analysis result C1 indicating that “the person 41 is moving” (“the person 41 is running” when the movement is fast) by means of the image analysis similarly to the case where the fixed camera photographs the same area. To sum up, the image analysis device 1 is capable of executing the image analysis in regard to the condition of the person 41 as the object with high accuracy. Incidentally, the number of frames of the image data used is not limited to three frames. Parenthetically, the image capturing device 10's position as the reference in the correction is not limited to the position P0. The image capturing device 10's position as the reference in the correction can also be the position P1 or the position P2. Further, the image capturing device 10's position as the reference in the correction can also be a position other than the position P0, P1 or P2 (e.g., a position between the position P0 and the position P1, a position between the position P1 and the position P2, or the like).

Incidentally, while the movement of the position of the person 41 was shown in FIGS. 7A and 7B as an example of the condition of the object, the image analysis device 1 may also analyze movement of a person's arm (up and down movement, left and right movement of the arm), movement of a person's foot (up and down movement, left and right movement of the foot), or the like as the condition of the object. In this case, the image analysis device 1 is capable of increasing the accuracy of the image analysis by acquiring information on the photographing direction of the image capturing device 10 as the position posture information on the image capturing device 10 and generating the time-series corrected image data C0 based on the position posture information.

### (1-4) Operation Example #2

FIGS. 8A and 8B are diagrams regarding an operation example #2 of the image analysis device 1 according to the first embodiment and showing a situation where an area a person 41 is passing through is photographed by the moving image capturing device 10 and the time-series corrected image data acquired by photographing the area the person passes through. As shown in FIG. 8A, when the moving person 41 is photographed by the image capturing device 10 moving in a direction of approaching the person 41 obliquely from the front, not only the person 41 but also the position of the image capturing device 10 moves in the order of the positions P0, P1, P2, . . . and the photographing area also moves. The time-series image data correction unit 12 of the image analysis device 1 according to the first embodiment receives the time-series image data A0 captured by the moving image capturing device 10 and the time-series position posture information B0 acquired by the position posture information acquisition unit 20, corrects the time-series image data A0 based on the time-series position posture information B0, and thereby generates the time-series corrected image data C0. As shown in FIG. 8B, the time-series image data correction unit 12 corrects the image data captured at the image capturing device 10's position P1 (time t+1) by using the image data captured at the image capturing device 10's position P0 (time t) as the reference as the reference image data, and thereby generates image data that could have been acquired if the photographing had been performed at the image capturing device 10's position P0 as the reference (i.e., image data corresponding to the position P0). Similarly, as shown in FIG. 8B, the time-series image data correction unit 12 corrects the image data captured at the image capturing device 10's position P2 (time t+2) by using the image data captured at the image capturing device 10's position P0 (time t) as the reference as the reference image data, and thereby generates image data that could have been acquired if the photographing had been performed at the image capturing device 10's position P0 as the reference (i.e., image data corresponding to the position P0). Subsequently, the image analysis unit 13 outputs the image analysis result C1 indicating the condition of the object by analyzing the condition of the object included in the time-series image data A0 based on the time-series corrected image data C0. As shown in FIG. 8B, each piece of the time-series corrected image data C0 is the same as each other in the position and the posture of the image capturing device 10, and the image analysis device is capable of outputting the image analysis result C1 indicating that “the person 41 is moving” (“the person 41 is running” when the movement is fast) by means of the image analysis similarly to the case where the fixed camera photographs the same area. To sum up, the image analysis device 1 is capable of executing the image analysis in regard to the condition of the person 41 as the object with high accuracy. Incidentally, in the operation example #2 in FIG. 8A, the actual photographing position approaches the person 41 in the order of the positions P0, P1, P2, and thus the size of the image based on the corrected image data at the position P1 is smaller than that at the position P0 and the size of the image based on the corrected image data at the position P2 is smaller than that at the position P1 as shown in FIG. 8B.

### (1-5) Comparative Example #3, Operation Example #3

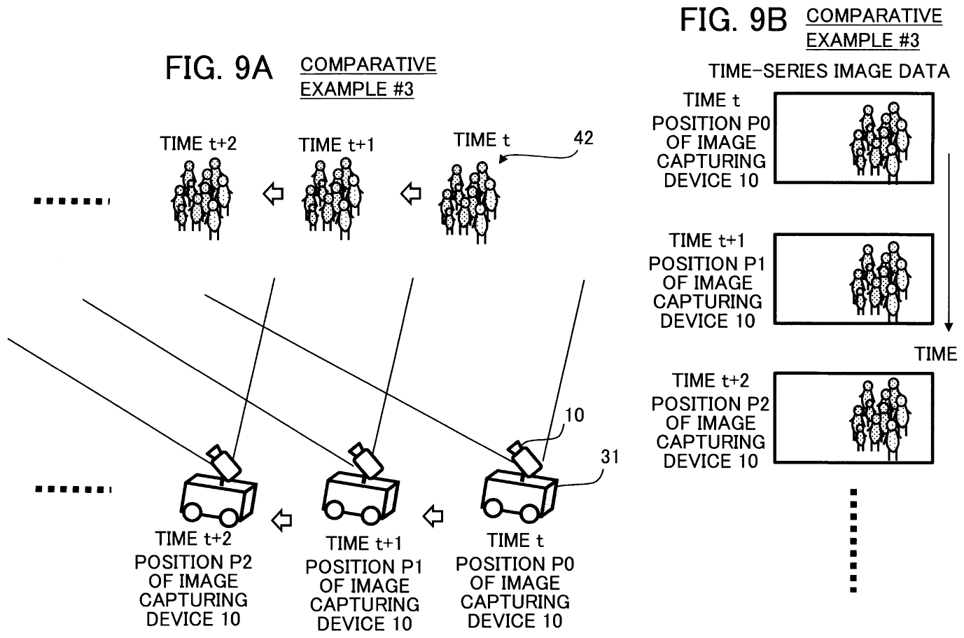

FIGS. 9A and 9B are diagrams regarding a comparative example #3 and showing a situation where an area a plurality of moving people 42 are passing through is photographed by the moving image capturing device 10 and the time-series image data acquired by photographing the area the plurality of people 42 pass through. As shown in FIG. 9A, when the plurality of people 42 as a moving crowd are photographed by the moving image capturing device 10, not only the plurality of people 42 but also the position of the image capturing device 10 moves in the order of the positions P0, P1, P2, . . . and the photographing area also moves. Therefore, the image analysis device in the comparative example #3, executing the image analysis by using the time-series image data at the times t, t+1, t+2, . . . captured by the image capturing device 10, might generate an image analysis result indicating that “the position of the plurality of photographed people is not moving” as shown in FIG. 9B. Put another way, in the case of using the moving image capturing device 10, each piece of the time-series image data has captured a different area as shown in FIG. 9B, and thus the image analysis device in the comparative example #3 might output the image analysis result indicating that “the crowd made up of the plurality of people 42 is stagnated in the passage” by means of the image analysis even though the crowd made up of the plurality of people 42 is moving in the passage. To sum up, in the image analysis device in the comparative example #3, the accuracy of the image analysis in regard to the condition of the plurality of people 42 as the object is low.

FIGS. 10A and 10B are diagrams regarding an operation example #3 of the image analysis device 1 according to the first embodiment and showing a situation where an area a plurality of moving people 42 are passing through is photographed by the moving image capturing device 10 and the time-series corrected image data acquired by photographing the area the plurality of people 42 pass through. As shown in FIG. 10A, when the plurality of moving people 42 are photographed by the moving image capturing device 10, not only the plurality of people 42 but also the position of the image capturing device 10 moves in the order of the positions P0, P1, P2, . . . and the photographing area also moves. The time-series image data correction unit 12 of the image analysis device 1 according to the first embodiment receives the time-series image data A0 captured by the moving image capturing device 10 and the time-series position posture information B0 acquired by the position posture information acquisition unit 20, corrects the time-series image data A0 based on the time-series position posture information B0, and thereby generates the time-series corrected image data C0. As shown in FIG. 10B, the time-series image data correction unit 12 corrects the image data captured at the image capturing device 10's position P1 (time t+1) by using the image data captured at the image capturing device 10's position P0 (time t) as the reference as the reference image data, and thereby generates image data that could have been acquired if the photographing had been performed at the image capturing device 10's position P0 as the reference (i.e., image data corresponding to the position P0). Similarly, as shown in FIG. 10B, the time-series image data correction unit 12 corrects the image data captured at the image capturing device 10's position P2 (time t+2) by using the image data captured at the image capturing device 10's position P0 (time t) as the reference as the reference image data, and thereby generates image data that could have been acquired if the photographing had been performed at the image capturing device 10's position P0 as the reference (i.e., image data corresponding to the position P0). Subsequently, the image analysis unit 13 outputs the image analysis result C1 indicating the condition of the object by analyzing the condition of the object included in the time-series image data A0 based on the time-series corrected image data C0. As shown in FIG. 10B, each piece of the time-series corrected image data C0 is the same as each other in the position and the posture of the image capturing device 10, and the image analysis device is capable of outputting an image analysis result C1 indicating that “the plurality of people 42 are moving”, namely, “the crowd is not stagnated” by means of the image analysis similarly to the case where the fixed camera photographs the same area. To sum up, the image analysis device 1 is capable of executing the image analysis in regard to the condition of the plurality of people 42 as the object with high accuracy.

### (1-6) Comparative Example #4, Operation Example #4

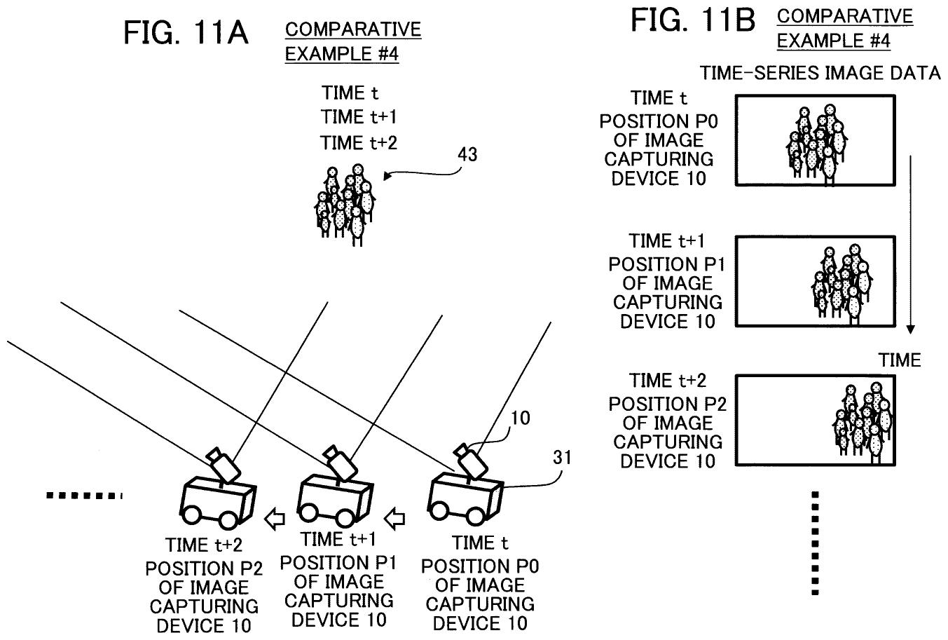

FIGS. 11A and 11B are diagrams regarding a comparative example #4 and showing a situation where an area a plurality of stagnated people 42 are passing through is photographed by the moving image capturing device 10 and the time-series image data acquired by photographing the area the plurality of people 42 pass through. As shown in FIG. 11A, when the plurality of people 43 as a stagnated crowd are photographed by the moving image capturing device 10, the position of the image capturing device 10 moves in the order of the positions P0, P1, P2, . . . and the photographing area moves. Therefore, the image analysis device in the comparative example #4, executing the image analysis by using the time-series image data at the times t, t+1, t+2, . . . captured by the image capturing device 10, might generate an image analysis result indicating that “the position of the plurality of people is moving” as shown in FIG. 11B. Put another way, in the case of using the moving image capturing device 10, each piece of the time-series image data has captured a different area as shown in FIG. 11B, and thus the image analysis device in the comparative example #4 might output the erroneous image analysis result indicating that “the crowd made up of the plurality of people 43 is moving in the passage” by means of the image analysis even though the crowd made up of the plurality of people 43 is stagnated in the passage. To sum up, in the image analysis device in the comparative example #4, the accuracy of the image analysis in regard to the condition of the plurality of people 43 as the object is low.

FIGS. 12A and 12B are diagrams regarding an operation example #4 of the image analysis device 1 according to the first embodiment and showing a situation where an area a plurality of people 43 as a stagnated crowd are passing through is photographed by the moving image capturing device 10 and the time-series corrected image data C0 acquired by photographing the area the plurality of people 43 pass through. As shown in FIG. 12A, when the plurality of people 43 not moving are photographed by the moving image capturing device 10, the position of the image capturing device 10 moves in the order of the positions P0, P1, P2, . . . and the photographing area moves. The time-series image data correction unit 12 of the image analysis device 1 according to the first embodiment receives the time-series image data A0 captured by the moving image capturing device 10 and the time-series position posture information B0 acquired by the position posture information acquisition unit 20, corrects the time-series image data A0 based on the time-series position posture information B0, and thereby generates the time-series corrected image data C0. As shown in FIG. 12B, the time-series image data correction unit 12 corrects the image data captured at the image capturing device 10's position P1 (time t+1) by using the image data captured at the image capturing device 10's position P0 (time t) as the reference as the reference image data, and thereby generates image data that could have been acquired if the photographing had been performed at the image capturing device 10's position P0 as the reference (i.e., image data corresponding to the position P0). Similarly, as shown in FIG. 12B, the time-series image data correction unit 12 corrects the image data captured at the image capturing device 10's position P2 (time t+2) by using the image data captured at the image capturing device 10's position P0 (time t) as the reference as the reference image data, and thereby generates image data that could have been acquired if the photographing had been performed at the image capturing device 10's position P0 as the reference (i.e., image data corresponding to the position P0). Subsequently, the image analysis unit 13 outputs the image analysis result C1 indicating the condition of the object by analyzing the condition of the object included in the time-series image data A0 based on the time-series corrected image data C0. As shown in FIG. 12B, each piece of the time-series corrected image data C0 is the same as each other in the position and the posture of the image capturing device 10, and the image analysis device is capable of outputting an image analysis result C1 indicating that “the plurality of people 43 are stagnated”, namely, “the crowd is not moving” by means of the image analysis similarly to the case where the fixed camera photographs the same area. To sum up, the image analysis device 1 is capable of executing the image analysis in regard to the condition of the plurality of people 43 as the object with high accuracy.

### (1-7) Effect

According to the first embodiment, the image analysis in regard to the condition of the object can be executed with high accuracy based on the time-series image data captured by the moving image capturing device 10 and the position posture information on the image capturing device 10.

### (2) Second Embodiment

### (2-1) Configuration

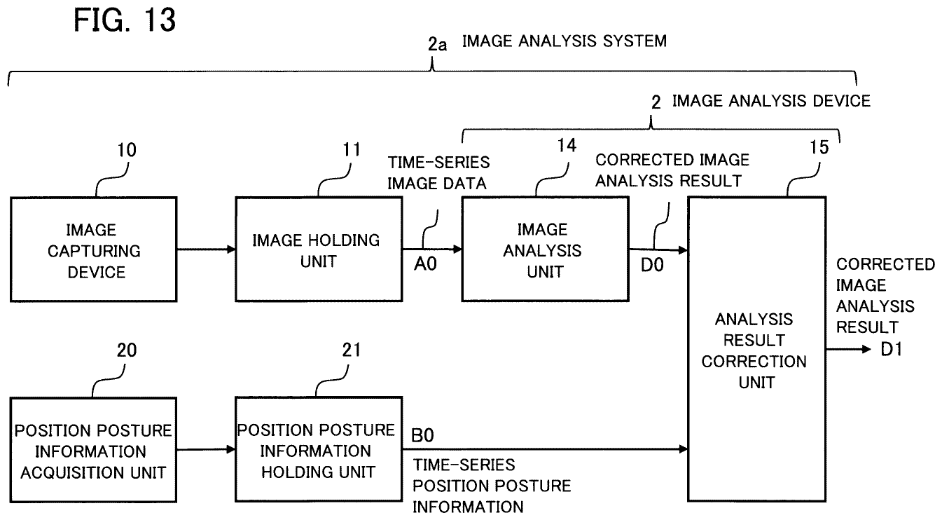

FIG. 13 is a block diagram showing the configuration of an image analysis system 2a (including an image analysis device 2) according to a second embodiment. The image analysis device 2 is a device capable of executing an image analysis method according to the second embodiment. The image analysis system 2a includes the image capturing device 10 such as a camera, the image holding unit 11 as a storage device that temporarily holds the image data captured by the image capturing device 10, an image analysis unit 14, and an analysis result correction unit 15. In the image analysis device 2 according to the second embodiment, each component identical or corresponding to a component of the image analysis device 1 according to the first embodiment is assigned the same reference character as in the first embodiment.

The image analysis unit 14 receives the time-series image data A0 captured by the moving image capturing device 10 and outputs an image analysis result D0 indicating the condition of the object by analyzing the condition of the object included in the time-series image data A0.

The analysis result correction unit 15 receives the image analysis result D0 and the time-series position posture information B0 acquired by the position posture information acquisition unit 20 that acquires the position posture information indicating the position and the posture of the image capturing device 10, corrects the image analysis result D0 based on the time-series position posture information B0, and thereby generates a corrected image analysis result D1. For example, the analysis result correction unit 15 determines the reference time, in the time in which the time-series image data A0 were captured, based on the time-series position posture information B0 and generates the corrected image analysis result D1 by modifying the image analysis result D0 indicating the condition of the object into an image analysis result that could have been acquired if the image capturing device 10 had been situated at the position at the reference time.

### (2-2) Operation

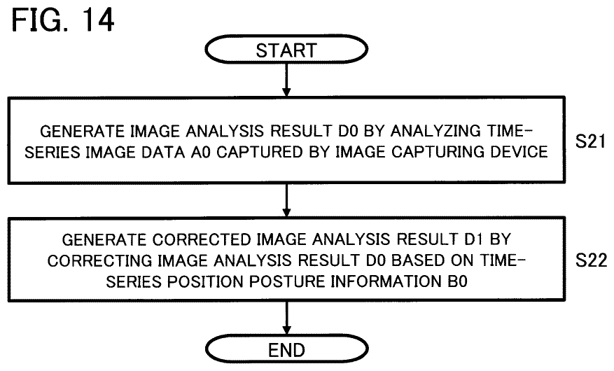

FIG. 14 is a flowchart showing the operation of the image analysis device 2 according to the second embodiment. As shown in step S21 in FIG. 14, the image analysis unit 14 receives the time-series image data A0 captured by the moving image capturing device 10 and generates the image analysis result D0 indicating the condition of the object by analyzing the condition of the object included in the time-series image data A0. Subsequently, as shown in step S22, the analysis result correction unit 15 receives the image analysis result D0 and the time-series position posture information B0 and outputs the corrected image analysis result D1 by correcting the image analysis result D0 based on the time-series position posture information B0.

### (2-3) Operation Example

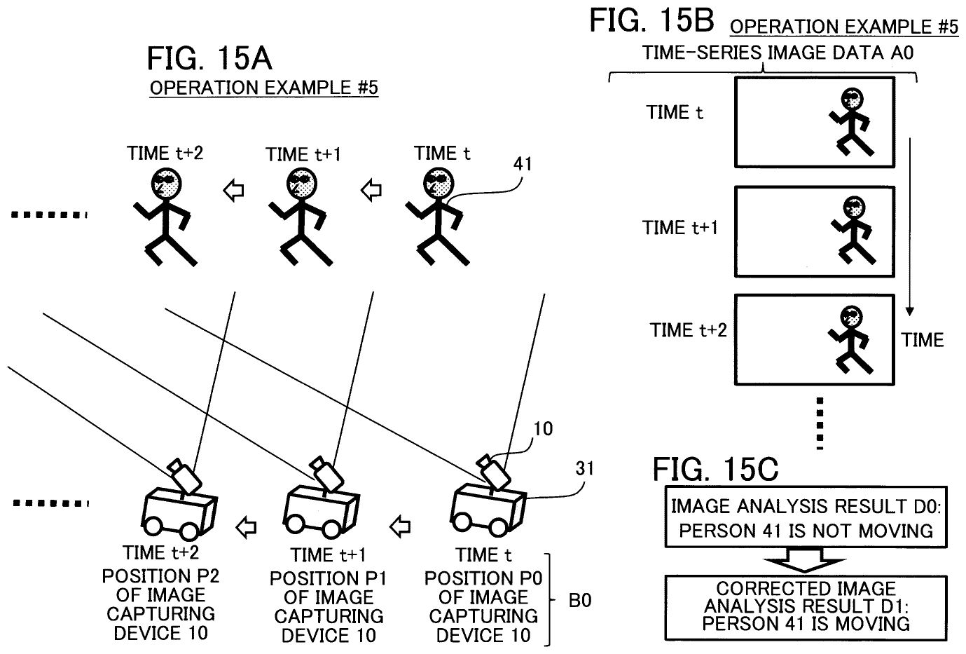

FIGS. 15A, 15B and 15C are diagrams regarding an operation example #5 of the image analysis device 2 according to the second embodiment and showing a situation where an area a moving person 41 is passing through is photographed by the moving image capturing device 10, the time-series image data A0 acquired by photographing the area the person 41 passes through, and the correction of the image analysis result D0. As shown in FIG. 15A, when the person 41 moving in the same direction as the moving direction of the image capturing device 10 is photographed by the moving image capturing device 10, the position of the image capturing device 10 moves in the order of the positions P0, P1, P2, . . . and the photographing area moves. The image analysis unit 14 of the image analysis device 2 according to the second embodiment receives the time-series image data A0 captured by the moving image capturing device 10 as shown in FIG. 15B and generates the image analysis result D0 by analyzing the condition of the person 41 based on the time-series image data A0. The analysis result correction unit 15 of the image analysis device 2 according to the second embodiment corrects the image analysis result D0 (e.g., “The person 41 is not moving.”) based on the time-series position posture information and thereby generates the corrected image analysis result D1 (e.g., “The person 41 is moving.”) as shown in FIG. 15C. As above, the image analysis device 2 according to the second embodiment is capable of executing the image analysis in regard to the condition of the person 41 as the object with high accuracy.

### (2-4) Effect

According to the second embodiment, the image analysis in regard to the condition of the object can be executed with high accuracy based on the time-series image data captured by the moving image capturing device and the position posture information on the image capturing device.

### DESCRIPTION OF REFERENCE CHARACTERS

1, 2: image analysis device, 1a, 2a: image analysis system, 10: image capturing device, 11: image holding unit, 12: time-series image data correction unit, 13: image analysis unit, 14: image analysis unit, 15: analysis result correction unit, 20: position posture information acquisition unit, 21: position posture information holding unit, 31: mobile robot (mobile object), 41: person (object), 42: a plurality of people (moving crowd), 43: a plurality of people (stagnated crowd), A0: time-series image data, B0: time-series position posture information, C0: time-series corrected image data, C1: image analysis result, D0: image analysis result, D1: corrected image analysis result.

1. An image analysis device comprising:
a time-series image data correction circuitry to receive time-series image data captured by a moving image capturing device and time-series position posture information acquired by a position posture information acquisition circuitry to acquire position posture information indicating a position and posture of the image capturing device, to correct the time-series image data based on the time-series position posture information, and thereby to generate time-series corrected image data; and
an image analysis circuitry to generate an image analysis result indicating condition of an object by analyzing the condition of the object included in the time-series image data based on the time-series corrected image data.

2. The image analysis device according to claim 1, wherein the time-series image data correction circuitry determines a reference time, in a time in which the time-series image data were captured, based on the time-series position posture information and generates the time-series corrected image data by modifying each piece of the time-series image data into image data that could have been acquired if the image capturing device had been situated at the position at the reference time.

3. An image analysis device comprising:
an image analysis circuitry to receive time-series image data captured by a moving image capturing device and to output an image analysis result indicating condition of an object by analyzing the condition of the object included in the time-series image data; and an analysis result correction circuitry to receive the image analysis result and time-series position posture information acquired by a position posture information acquisition circuitry to acquire position posture information indicating a position and posture of the image capturing device and to generate a corrected image analysis result by correcting the image analysis result based on the time-series position posture information.

4. The image analysis device according to claim 3, wherein the analysis result correction circuitry determines a reference time, in a time in which the time-series image data were captured, based on the time-series position posture information and generates the corrected image analysis result by modifying the image analysis result indicating the condition of the object into an image analysis result that could have been acquired if the image capturing device had been situated at the position at the reference time.

5. The image analysis device according to claim 1, wherein the time-series position posture information includes position information on the image capturing device and information indicating a photographing direction.

6. The image analysis device according to claim 1, wherein the image analysis circuitry determines an action of a person as the condition of the object.

7. The image analysis device according to claim 1, wherein the image analysis circuitry determines whether a person as the object is moving or stopped.

8. The image analysis device according to claim 1, wherein the image analysis circuitry determines whether a crowd as the object is stagnated or moving.

9. An image analysis system comprising:
an image capturing device that is movable;
a position posture information acquisition circuitry to acquire position posture information indicating a position and posture of the image capturing device;
a time-series image data correction circuitry to receive time-series image data captured by the moving image capturing device and time-series position posture information acquired by the position posture information acquisition circuitry, to correct the time-series image data based on the time-series position posture information, and thereby to generate time-series corrected image data; and
an image analysis circuitry to generate an image analysis result indicating condition of an object by analyzing the condition of the object included in the time-series image data based on the time-series corrected image data.

10. The image analysis system according to claim 9, wherein the time-series image data correction circuitry determines a reference time, in a time in which the time-series image data were captured, based on the time-series position posture information and generates the time-series corrected image data by modifying each piece of the time-series image data into image data that could have been acquired if the image capturing device had been situated at the position at the reference time.

11. An image analysis system comprising:
an image capturing device that is movable;
a position posture information acquisition circuitry to acquire position posture information indicating a position and posture of the image capturing device;
an image analysis circuitry to receive time-series image data captured by the moving image capturing device and to output an image analysis result indicating condition of an object by analyzing the condition of the object included in the time-series image data; and
an analysis result correction circuitry to receive the image analysis result and time-series position posture information acquired by the position posture information acquisition circuitry and to generate a corrected image analysis result by correcting the image analysis result based on the time-series position posture information.

12. The image analysis system according to claim 11, wherein the analysis result correction circuitry determines a reference time, in a time in which the time-series image data were captured, based on the time-series position posture information and generates the corrected image analysis result by modifying the image analysis result indicating the condition of the object into an image analysis result that could have been acquired if the image capturing device had been situated at the position at the reference time.

13. The image analysis system according to claim 9, wherein the time-series position posture information includes position information on the image capturing device and information indicating a photographing direction.

14. The image analysis system according to claim 9, wherein the image analysis circuitry determines an action of a person as the condition of the object.

15. The image analysis system according to claim 9, wherein the image analysis circuitry determines whether a person as the object is moving or stopped.

16. The image analysis system according to claim 9, wherein the image analysis circuitry determines whether a crowd as the object is stagnated or moving.

17. An image analysis method to be executed by an image analysis device that receives time-series image data captured by a moving image capturing device and time-series position posture information acquired by a position posture information acquisition circuitry to acquire position posture information indicating a position and posture of the image capturing device, the method comprising:
correcting the time-series image data based on the time-series position posture information and thereby generating time-series corrected image data; and
generating an image analysis result indicating condition of an object by analyzing the condition of the object included in the time-series image data based on the time-series corrected image data.

18. (canceled)

19. An image analysis method to be executed by an image analysis device that receives time-series image data captured by a moving image capturing device and time-series position posture information acquired by a position posture information acquisition circuitry to acquire position posture information indicating a position and posture of the image capturing device, the method comprising:
outputting an image analysis result indicating condition of an object by analyzing the condition of the object included in the time-series image data; and
generating a corrected image analysis result by correcting the image analysis result based on the time-series position posture information.

20. (canceled)
